(19) United States
(12) Patent Application Publication
(10) Pub. No.: US 2020/0335994 A1
(43) Pub. Date: Oct. 22, 2020

(54) METHOD OF MANAGING CHARGING CIRCUIT AND SYSTEM FOR MANAGING THE SAME

(71) Applicant: ADCRUNCH CO.,LTD, JEJU-SI (KR)

(72) Inventor: Seung Min SHIN, Jeju-si (KR)

(21) Appl. No.: 16/957,565

(22) PCT Filed: Dec. 19, 2018
(86) PCT No.: PCT/KR2018/016223

§ 371 Date: Jun. 24, 2020

(30) Foreign Application Priority Data
Dec. 29, 2017 (KR) 10-2017-0184191

(51) Int. Cl. H02J 7/00

(52) U.S. Cl. CPC H02J 7/007182; H02J 7/0044; H02J 7/0048

(57) ABSTRACT

The present invention provides a method of managing a charging circuit including a step of connecting an adjacent charging device and a mobile terminal through wired or wireless communication, a step of displaying a screen for controlling the charging device on the display of the mobile terminal, a step of inputting a charging value and a charging stop value through the control screen displayed on the display, and a step of querying the status value of the mobile terminal and transmitting a charging signal to the charging device when the status value is less than or equal to the charging value input through the control screen.

### TECHNICAL FIELD

The present invention relates to a method of controlling a charging circuit for charging a mobile terminal and a system for managing the charging circuit.

### BACKGROUND ART

As mobile terminals such as smartphones and tablets are widely used, research on mobile terminal technologies is actively being conducted. In particular, increasing the battery capacity of a mobile terminal is a very important issue.

However, with the trend toward miniaturization of mobile terminals, there is a limit in increasing battery capacity. Accordingly, to charge a mobile terminal at any time, a user is inconvenienced by having to carry a dedicated cable for charging.

In addition to the inconvenience of carrying a dedicated cable, to supply power to a mobile terminal, a user needs to find an electrical outlet to connect the dedicated cable. For these reasons, many people carry an external battery pack.

However, when a mobile terminal is used while connected to an external battery pack, power is continuously supplied to the battery of the mobile terminal even after charging is completed. As a result, the battery lifespan of the mobile terminal may be shortened, and the use of power of the external battery pack may be inefficient.

To solve these problems, research on technology for controlling battery charging conditions by installing an application on a mobile terminal is being conducted.

### DISCLOSURE

### Technical Problem

Therefore, the present invention has been made in view of the above problems, and it is one object of the present invention to provide a circuit management system and method that enable control of a charging circuit for charging a mobile terminal depending on the charging status of the mobile terminal.

### Technical Solution

In accordance with one aspect of the present invention, provided is a method of managing a charging circuit including a step of connecting an adjacent charging device and a mobile terminal through wired or wireless communication; a step of displaying a screen for controlling the charging device on a display of the mobile terminal; a step of inputting a charging value and a charging stop value through the control screen displayed on the display; and a step of querying a status value of the mobile terminal and transmitting a charging signal to the charging device when the status value is less than or equal to the charging value input through the control screen.

According to one embodiment of the present invention, the method of managing a charging circuit may include a step of transmitting a charging stop signal to the charging device when the status value of the mobile terminal is greater than or equal to the charging stop value.

According to one embodiment of the present invention, the charging device may be configured so that a switch of the charging circuit inside the charging device is turned on when the charging device receives the charging signal.

According to one embodiment of the present invention, the charging device may be configured so that the switch of the charging circuit inside the charging device is turned off when the charging device receives the charging stop signal.

In accordance with another aspect of the present invention, provided is a system for managing a charging circuit using an application, the system including a mobile terminal; a protective case formed to surround an outside of the mobile terminal and including a communicator for transmitting or receiving data to or from the mobile terminal by wire or wirelessly, a power supply that is electrically connected to a battery of the mobile terminal, and a power supply controller for turning on/off the power supply; and an application installed on the mobile terminal to connect the mobile terminal and the communicator and responsible for driving the power supply controller based on a charging value and a charging stop value input through the mobile terminal.

### Advantageous Effects

According to one embodiment of the present invention, the circuit of a charging device connected to a mobile terminal can be turned on or off using an application installed on the mobile terminal. Thereby, the charging status of the mobile terminal can be managed more simply.

In addition, a charging value and a charging stop value can be set using the application. Accordingly, charging can be performed only when a remaining battery capacity is within a certain range.

### DESCRIPTION OF DRAWINGS

FIG. 1 is a conceptual diagram of a charging device used in the present invention.

FIG. 2 is a flowchart for explaining a charging management system using an application according to one embodiment of the present invention.

FIG. 3 is a conceptual diagram of a charging management system using an application according to one embodiment of the present invention.

### BEST MODE

Hereinafter, the present invention will be described in more detail with reference to the drawings. In this specification, the same or similar elements are denoted by the same or similar reference numerals even in different embodiments, and the description thereof will be replaced by the first one. Singular expressions encompass plural expressions unless clearly specified otherwise in context.

In addition, as used in the following description, suffixes for components such as “module” or “part” are given only considering the ease of writing the specification, and the suffixes themselves are not used for the purpose of distinguishing the components from each other.

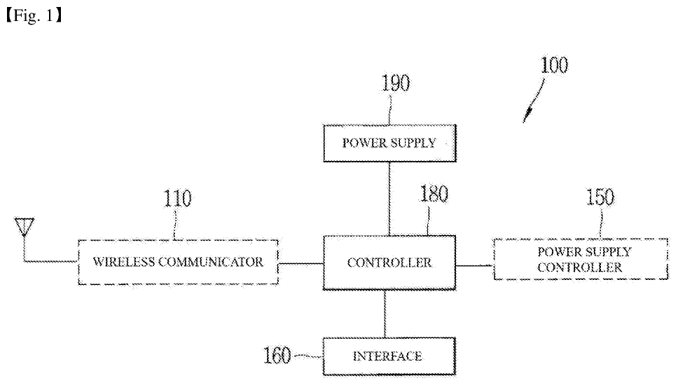

FIG. 1 is a conceptual diagram of a charging device used in the present invention.

Referring to FIG. 1, a charging device 100 may include a wireless communicator 110, a power supply 190, a power supply controller 150, an interface 160, a controller, and the like. The components shown in FIG. 1 are not essential for implementing the charging device 100. Accordingly, the charging device 100 according to the present invention may include additional components other than those listed above or may not include some of the components listed above. In addition, the charging device 100 may be provided in the form of a protective case mounted on a mobile terminal.

Among the above components, the wireless communicator 110 may include one or more modules that enable wireless communication between the charging device 100 and a wireless communication system, between the charging device 100 and a mobile terminal, or between the charging device 100 and an external server. In addition, the wireless communicator 110 may include one or more modules that serve to connect the charging device 100 to one or more networks.

The wireless communicator 110 may include at least one of a wireless Internet module, a short-range communication module, and a location information module.

The interface 160 serves as a passage for various external devices connected to the charging device 100. The interface 160 may include at least one of a wired/wireless headset port, an external charger port, a wired/wireless data port, a memory card port, a port for connecting devices equipped with an identification module, an audio input/output (I/O) port, a video input/output (I/O) port, and an earphone port. In addition, the charging device 100 may be connected to a mobile terminal via the interface 160.

The power supply 190 supplies power, under the control of the power supply controller 150, to a mobile terminal connected by wire or wirelessly. The power supply 190 may include a battery. In this case, the battery may be a built-in battery or a replaceable battery.

When the power supply 190 is connected to a mobile terminal, the power supply 190 supplies power to the mobile terminal. When the power supply 190 is connected to an external power source, the power supply 190 is powered by the external power source to charge the battery of the power supply 190.

The power supply controller 150 controls a charging circuit so that the power supply 190 is connected to or disconnected from a mobile terminal. The power supply controller 150 receives a signal form an application to turn on/off the charging circuit.

In addition to operations related to the application, the controller controls the overall operation of a mobile terminal. The controller may operate, in a combination manner, two or more of components included in the charging device 100.

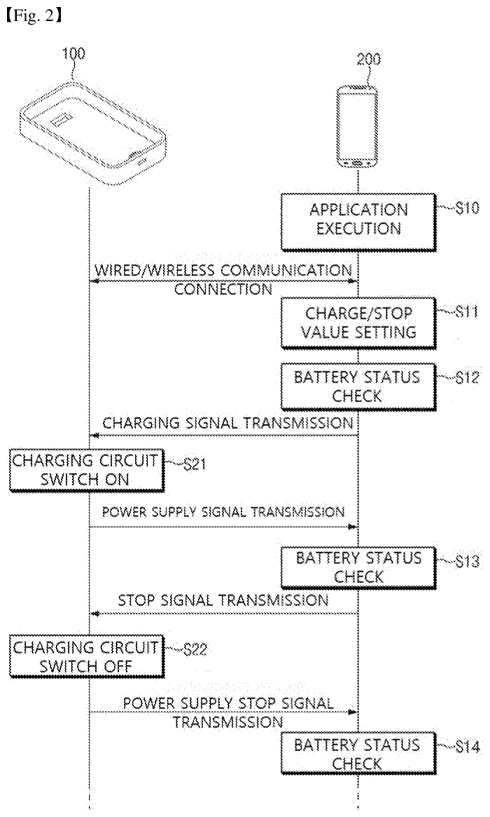

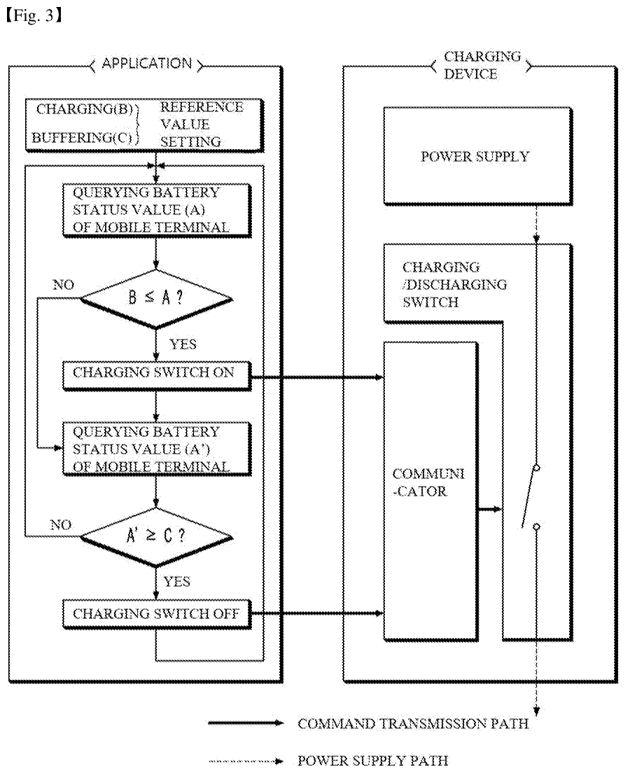

FIG. 2 is a flowchart for explaining a charging management system using an application according to one embodiment of the present invention, and FIG. 3 is a conceptual diagram of a charging management system using an application according to one embodiment of the present invention.

Referring to FIGS. 2 and 3, when a charge management application is executed in a mobile terminal (S10), the application searches for the adjacent charging devices 100 through the communicator of the mobile terminal. Among the adjacent charging devices 100, the device approved through the application is connected to the mobile terminal by wire or wirelessly.

When the charging device 100 is connected to the mobile terminal, a control screen is displayed on the display of the mobile terminal by the application. The control screen includes a menu for setting a charging value (charging reference setting value) and a charging stop value (buffering reference setting value).

The charging value and the charging stop value may be arbitrarily set by a user or automatically set (S11).

By the application, the charging capacity of the charging device 100 may be checked and a charging section may be set automatically. For example, by the application, the mobile terminal and the charging device 100 may be connected to each other, the battery capacity of the charging device 100 may be checked, and then a charging value and a charging stop value for the mobile terminal may be set automatically. In this case, when the battery capacity of the charging device 100 is small, the number of times a switch is turned on/off may be reduced by increasing the difference between the charging value and the charging stop value.

The application may remember a charging value and a charging stop value corresponding to a device connected to the application, and then may automatically set the same charging value and charging stop value when connected to the same device.

After setting a charging value and a charging stop value, the battery status of the mobile terminal is queried by the application (S12).

When the charging level of the battery of the mobile terminal is less than or equal to the charging value, the application transmits a charging signal to the charging device 100. Then, the charging device 100 receiving the charging signal turns on the switch of the charging circuit to supply power to the battery of the mobile terminal.

When the switch of the charging circuit is turned on, the charging device 100 transmits a power supply signal to the mobile terminal. The power supply signal may be transmitted at regular time intervals. That is, after a certain period of time after power supply starts, the power supply signal is transmitted to the mobile terminal, and the mobile terminal receiving the power supply signal checks a battery status again (S13).

When the charging level of the battery of the mobile terminal is greater than or equal to the charging stop value, the application transmits a charging stop signal to the charging device 100. Then, the charging device 100 receiving the charging stop signal turns off the switch of the charging circuit to cut off power supplied to the battery of the mobile terminal.

When the switch of the charging circuit is turned off, the charging device 100 transmits a power supply stop signal to the mobile terminal. In this case, the power supply stop signal may be transmitted at regular time intervals. That is, after a certain period of time after power supply is stopped, the power supply stop signal is transmitted to the mobile terminal, and then the mobile terminal receiving the power supply stop signal checks the battery status again (S14).

According to another embodiment of the present invention, a method of managing a charging circuit using an application executed through a mobile terminal is disclosed. The method includes a step of connecting an adjacent charging device and a mobile terminal to each other through wired or wireless communication by an application, a step of displaying a screen for controlling the charging device on the display of the mobile terminal by the application, a step of inputting a charging value and an arbitrary charging stop value below a battery full charging value through the control screen displayed on the display, and a step of, by the application, querying the status value of the mobile terminal at regular time intervals and transmitting a charging signal or a charging stop signal to the charging device. In this case, when a charging buffer space is formed between the battery full charging value and the charging stop value and the status value of the mobile terminal is queried by the application, and when the battery value of the mobile terminal is greater than or equal to the charging stop value, the connection of a charging circuit switch inside the charging device is physically disconnected.

In addition, according to another embodiment of the present invention, the method of managing a charging circuit using an application further includes a step of, by the application, checking the battery capacity of the charging device and automatically adjusting a charging section. In this case, when connecting with the charging device, when the battery capacity of the charging device is lower than a battery capacity when a previous charging section is set, the charging section is reduced by the application.

In addition, according to another embodiment of the present invention, a system for managing a charging circuit using an application is disclosed. The system includes a mobile terminal; a protective case formed to surround the outside of the mobile terminal and including a communicator for transmitting data to or receiving data from the mobile terminal by wire or wirelessly, a power supply that is electrically connected to the battery of the mobile terminal, and a power supply controller for turning on/off the power supply; and an application installed on the mobile terminal to connect the mobile terminal and the communicator and responsible for driving the power supply controller based on a charging value and a charging stop value input through the mobile terminal. In this case, the status value of the mobile terminal is queried at regular time intervals by the application. When querying the status value, when the battery value of the mobile terminal is a value between a full charging value and a charging stop value, the application transmits a charging stop signal to the protective case so that the power supply controller inside the protective case physically disconnects a switch.

Full charging is a state wherein minimum current is continuously consumed, rather than a state wherein charging is completed and further charging is stopped. That is, judging “100% charging” is based on a resistance value between a battery and a charger, and when the value approaches the maximum charge of the battery, it is judged as “full charging”. In this case, at the same time that charging is cut off, the battery starts self-consumption and immediately falls below 100%, and the charger remains on.

For example, when charging is performed by inserting a battery into a cradle charger, when the battery is fully charged, a green LED is turned on. 1 to 2 minutes after removing the battery from the charger, when the battery is inserted into the cradle charger, a red LED turns on and the green LED turns on after a while.

As described above, in the case of all electric devices using a charger, in a fully charged section (green LED ON), power is not cut off and minimum current is continuously supplied.

According to the embodiments described above, in the present invention, a charging stop value less than a full charging value is set. When a battery charge falls between the full charging value and the charging stop value (charging buffer space), the switch of the charging device is physically disconnected, so that power consumption corresponding to minimum current does not occur.

According to the present invention, to reduce power consumption of a mobile terminal, the application queries the status value of the mobile terminal at regular time intervals (time until charging is performed exceeding an upper charging limit). Due to these terms, a battery level may exceed the charging stop value. In the present invention, a charging buffer space is formed to minimize waste of power generated in these terms (a state wherein charging is being performed in an extra space).

In the present invention, to minimize power consumption and waste of power of a mobile terminal due to driving of the application (terms occurring until a charging upper limit is exceeded), a charging buffer space is set.

In addition, when the charging device is connected to the mobile terminal, and the charging device has a large battery capacity, the charging device may be controlled more precisely by reducing a charging section. When the charging device has a small battery capacity, power consumed in the control of a switch may be reduced by increasing the charging section.

More specifically, the application turns on the switch of the charging device when the battery level of the mobile terminal is less than or equal to the charging value, and turns off the switch of the charging device when the battery level of the mobile terminal is greater than or equal to the charging stop value. That is, when the charging section is wide, the number of switch operations decreases, and when the charging section is narrow, the number of switch operations increases.

In the present invention, as described above, the application queries the status value of the mobile terminal at a time interval equal to or greater than a certain term to reduce power consumption, and at the same time, automatically adjusts the charging section (ranges of the charging value and the charging stop value) to minimize power consumption due to switch operation.

According to the embodiments described above, the circuit of a charging device connected to a mobile terminal may be turned on or off using an application installed on the mobile terminal. Thereby, the charging status of the mobile terminal may be managed more simply.

In addition, a charging value and a charging stop value may be set using the application. Accordingly, charging may be performed only when a remaining battery capacity is within a certain range.

The charging management application and system described above are not limited to the configurations and methods of the above-described embodiments, and all or some of the embodiments may be selectively combined to constitute various modifications.

1. A method of managing a charging circuit, wherein the charging circuit is executed through a mobile terminal, and the method comprises a step of connecting an adjacent charging device and the mobile terminal through wired or wireless communication;
a step of displaying a screen for controlling the charging device on a display of the mobile terminal;
a step of inputting a charging value and a charging stop value through the control screen displayed on the display; and
a step of querying a status value of the mobile terminal and transmitting a charging signal to the charging device when the status value is less than or equal to the charging value input through the control screen.

2. The method according to claim 1, comprising a step of transmitting a charging stop signal to the charging device when the status value of the mobile terminal is greater than or equal to the charging stop value.

3. The method according to claim 2, wherein the charging device is configured so that a switch of the charging circuit inside the charging device is turned on when the charging device receives the charging signal.

4. The method according to claim 3, wherein the charging device is configured so that the switch of the charging circuit inside the charging device is turned off when the charging device receives the charging stop signal.

5. A system for managing a charging circuit using an application, comprising:
a mobile terminal;
a protective case formed to surround an outside of the mobile terminal and comprising a communicator for transmitting or receiving data to or from the mobile terminal by wire or wirelessly, a power supply that is electrically connected to a battery of the mobile terminal, and a power supply controller for turning on/off the power supply; and
an application installed on the mobile terminal to connect the mobile terminal and the communicator and responsible for driving the power supply controller based on a charging value and a charging stop value input through the mobile terminal.
